(19) United States
(12) Patent Application Publication
(10) Pub. No.: US 2025/0078650 A1
(43) Pub. Date: Mar. 6, 2025

(54) ROAD SECTION INFORMATION DETERMINATION METHOD AND APPARATUS, DEVICE, AND MEDIUM

(71) Applicant: Luxshare Precision Industry Company Limited, SHENZHEN (CN)

(72) Inventors: Guanhsiung WANG, SHENZHEN (CN); Wei Hsin CHEN, SHENZHEN (CN)

(73) Assignee: Luxshare Precision Industry Company Limited, SHENZHEN (CN)

(21) Appl. No.: 18/782,752

(22) Filed: Jul. 24, 2024

(30) Foreign Application Priority Data
Sep. 6, 2023 (CN) 202311146352.3

(51) Int. Cl. G08G 1/01; G08G 1/04

(52) U.S. Cl. CPC G08G 1/0108; G08G 1/04

(57) ABSTRACT

Provided are a road section information determination method and apparatus, a device, and a medium. The method is applied to an assistance system. The method includes acquiring first running state information of a vehicle in a traffic road section and second running state information transmitted by an associated assistance system in the traffic road section; in response to an associated signal indicator light satisfying an information determination condition, determining road section information of the traffic road section based on the first running state information, the second running state information, and preset road section attribute information; and sending the road section information to an assistance vehicle corresponding to the assistance system.

### CROSS-REFERENCE TO RELATED APPLICATION(S)

This application claims priority to the Chinese Patent Application No. 202311146352.3 filed on Sep. 6, 2023, the disclosure of which is incorporated herein by reference in its entirety.

### TECHNICAL FIELD

The present application relates to the field of traffic technology, particularly a road section information determination method and apparatus, a device, and a medium.

### BACKGROUND

The field of view (FOV) of an electric vehicle is limited by the mounting height of the sensor. The low mounting height of the sensor and the limited line of sight (LOS) make the vehicle-mounted sensor easy to occlude by a building or a large vehicle. As a result, detection blindness occurs, making it impossible to provide accurate road section environment information for the vehicle.

Therefore, to provide more secure traffic and environmental information for a vehicle, an intelligent traffic assistance system installed on a roadside infrastructure is commonly used at present. The intelligent traffic assistance system generally includes a roadside sensor such as a camera or a lidar, providing road section environmental information including blindness for the vehicle.

However, a camera as a roadside sensor is sensitive to light and weather and is low in angular resolution. A camera as a roadside sensor is higher in angular resolution but is also easily affected by bad weather and strong light and is high in costs. When affected by these factors, a roadside sensor provides inaccurate detected road section environment information.

### SUMMARY

The present application provides a road section information determination method and apparatus, a device, and a medium.

According to a first aspect of the present application, a road section information determination method is provided. The method is applied to an assistance system. The method includes acquiring first running state information of a vehicle in a traffic road section and second running state information transmitted by an associated assistance system in the traffic road section; in response to an associated signal indicator light satisfying an information determination condition, determining road section information of the traffic road section based on the first running state information, the second running state information, and preset road section attribute information; and sending the road section information to an assistance vehicle corresponding to the assistance system.

According to a second aspect of the present application, a road section information determination apparatus is provided. The apparatus includes an information acquisition module configured to acquire first running state information of a vehicle in a traffic road section and second running state information transmitted by an associated assistance system in the traffic road section; an information determination module configured to, in response to an associated signal indicator light satisfying an information determination condition, determine road section information of the traffic road section based on the first running state information, the second running state information, and preset road section attribute information; and an information sending module configured to send the road section information to an assistance vehicle corresponding to the assistance system.

According to a third aspect of the present application, an electronic device is provided. The device serves as the assistance system and the associated assistance system of the road section information determination method of any embodiment of the present application. The device includes at least one processor and a memory communicatively connected to the at least one processor.

The memory stores a computer program executable by the at least one processor to enable the at least one processor to perform the road section information determination method of any embodiment of the present application.

According to a fourth aspect of the present application, a computer-readable storage medium is provided. The medium stores computer instructions configured to, when executed, cause a processor to perform the road section information determination method of any embodiment of the present application.

### BRIEF DESCRIPTION OF DRAWINGS

To illustrate solutions of embodiments of the present application more clearly, drawings used in description of embodiments of the present application are described hereinafter. Apparently, these drawings illustrate part of embodiments of the present application. Those of ordinary skill in the art may obtain other drawings based on these drawings on the premise that no creative work is done.

FIG. 1 is a flowchart of a road section information determination method according to an embodiment of the present application.

FIG. 2 is a diagram illustrating the structure of an assistance system of a road section information determination method according to an embodiment of the present application.

FIG. 3 is a flowchart of a road section information determination method according to an embodiment of the present application.

FIG. 4 is a diagram illustrating a traffic road section of a road section information determination method according to an embodiment of the present application.

FIG. 5 is an example flowchart of a road section information determination method according to an embodiment of the present application.

FIG. 6 is another example flowchart of a road section information determination method according to an embodiment of the present application.

FIG. 7 is a diagram illustrating the structure of a road section information determination apparatus according to an embodiment of the present application.

FIG. 8 is a diagram illustrating the structure of an electronic device for implementing any embodiment of the present application.

### DETAILED DESCRIPTION

For a better understanding of the solutions of the present application by those skilled in the art, the technical solutions in embodiments of the present application are described clearly and completely below in conjunction with the drawings in embodiments of the present application. Apparently, the embodiments described below are merely part, not all, of embodiments of the present application. Based on embodiments of the present application, all other embodiments obtained by those of ordinary skill in the art on the premise that no creative work is done are within the scope of the present application.

It is to be noted that the terms “first”, “second” and the like in the description, claims and drawings of the present disclosure are used to distinguish between similar objects and are not necessarily used to describe a particular order or sequence. It is to be understood that the data used in this way is interchangeable where appropriate so that embodiments of the present application described herein may also be implemented in a sequence not illustrated or described herein. Additionally, terms “including” and “having” or any variations thereof are intended to encompass a non-exclusive inclusion. For example, a process, method, system, product, or device that includes a series of steps or units not only includes the expressly listed steps or units but may also include other steps or units that are not expressly listed or are inherent to such a process, method, product, or device.

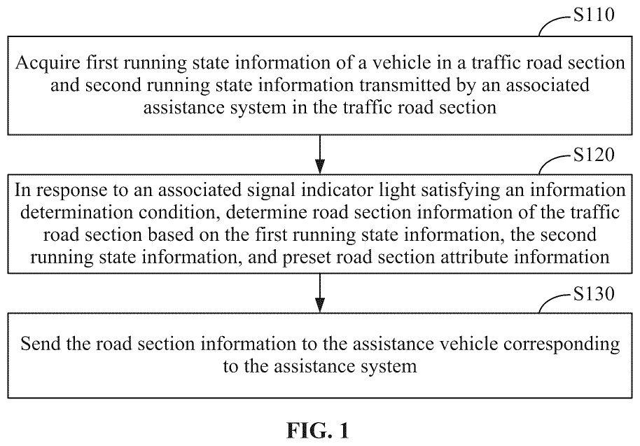

FIG. 1 is a flowchart of a road section information determination method according to an embodiment of the present application. This embodiment may be applied to the case of traffic road section. The method may be performed by a road section information determination apparatus. The apparatus may be implemented by software and/or hardware. The apparatus may be configured in an electronic device. As shown in FIG. 1, the method includes S110, S120, and S130.

In S110, first running state information of a vehicle in a traffic road section and second running state information transmitted by an associated assistance system in the traffic road section are acquired.

The assistance system of the present application may use a 77-GHz frequency-modulated continuous-wave (FM-CW) lidar. A lidar is limited by FOV and LOS. The vertical FOV and horizontal FOV of lidar waves are limited angles. At present, most roadside lidars can detect only a static occlusion caused by a static object such as a building, a terrain, or a raised median. A larger or higher vehicle, if present, between a lidar and a target vehicle occludes the LOS of the lidar. As a result, the lidar cannot detect the target vehicle. Dynamic occlusion thus occurs.

Therefore, the present application uses a system deployed at a lower position of a traffic light at a raised median to detect the identifier (ID) of a user vehicle of the roadside assistance system and to allocate a lidar channel to the user vehicle. That is, a lidar is deployed at a lower position of the traffic light at the start position (position where a vehicle enters the road section) of the road section. Since the vertical FOV of a lidar is usually narrow, another system is deployed at a higher position of a traffic light at a raised median of the same road section to increase the vertical FOV and LOS by using the obliquity of an adjusted lidar to detect information such as the speed and distance of the vehicle at a higher FOV to avoid dynamic occlusion. The available frequency band of a lidar is limited. Therefore, allocation of the lidar channel to the user vehicle by the system deployed at the lower position of the traffic light at the raised median can avoid the problem of mutual interference between the lidars.

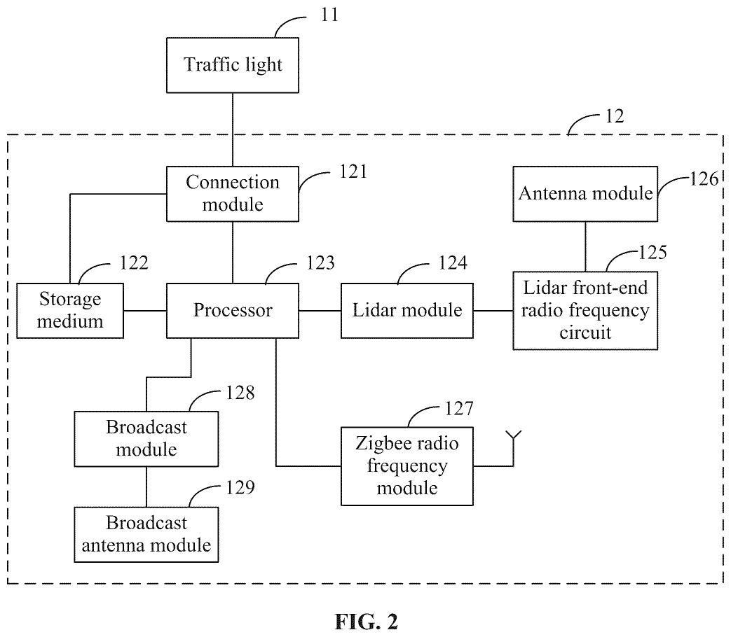

Illustratively, to facilitate understanding of the structure of the assistance system of the present application, an example description is given. FIG. 2 is a diagram illustrating the structure of an assistance system of a road section information determination method according to an embodiment of the present application. As shown in FIG. 2, a traffic light 11 is connected to an assistance system 12. The assistance system 12 includes a connection module 121, a storage medium 122, a processor 123, a lidar module 124, a lidar front-end radio frequency circuit 125, an antenna module 126, a Zigbee radio frequency module 127, a broadcast module 128, and a broadcast antenna module 129. The lidar module 124 and the lidar front-end radio frequency circuit 125 may use a 77-GHz continuous-wave lidar technology: FM-CW lidar. The antenna module 126 includes at least one transmitting antenna and one receiving antenna. The operation principle of the 77-GHz FM-CW lidar is that the millimetre wave (mmWave) technology such as the 77-GHz FM-CW lidar is a special lidar technology that uses a short-wave constant electromagnetic wave. This technology emits an electromagnetic wave. The emitted electromagnetic wave bumps into an object and is reflected. The reflected signal is intercepted so that the distance, speed, and angle of the object are obtained. A sinusoid signal from the FM-CW lidar is called a chirp, with the frequency increasing linearly with time. An object is in front of the lidar. TX emits a chirp onto the object and then is reflected. RX receives the reflected chirp. In this process, there is a time delay τ: the round-trip time τ between TX and RX. Due to the round-trip time τ, a frequency tone S_{τ} is generated so that an intermediate frequency (IF) signal (Sin signal wave at the frequency S_{τ}) is obtained. With the round-trip time between the object and the lidar, the speed of the detected object equals the distance divided by the time. The frequency of TX minus the frequency of RX is equal to the frequency of the IF signal. The IF signal is a Sin wave at the fixed frequency tone (S_{τ}). In delay (τ), τ is equal to twice distance divided by the speed of light. Detection range resolution d (res) is equal to the speed of light divided by twice bandwidth. Maximum detection range d (max) is equal to the product of the speed of light and the ADC sampling rate Fs divided by S, where S is equal to the chirp bandwidth divided by chirp interval. Under the fixed chirp bandwidth (B), the slower the chirp (the longer the delay τ) means the smaller the slope, and the larger the available detection range.

The broadcast module 128 and the broadcast antenna module 129 are used to broadcast the following information to a user of an assistance system: 1. related information about vehicle speed, distance, and position of neighboring vehicles; and 2. the road section information of the traffic road section. The Zigbee radio frequency module 127 is configured to connect multiple assistance systems with low power consumption. 802.15.4 technology such as the Zigbee radio frequency module is used for connecting multiple assistance systems in information exchange and transceiving. The Zigbee radio frequency module 127 is configured to synchronize multiple assistance systems. The Zigbee radio frequency module 127 is configured to send Beacon signals regularly. Information exchange and transceiving between assistance systems is processed by the Zigbee radio frequency module 127 between the assistance systems, so time synchronization is also performed by Beacon signals sent by the two assistance systems. The connection module 121 connects the power supply system of a traffic light to an assistance system to supply power to the assistance system and is configured to receive the signal state of the traffic light. The signal state of the traffic light may be obtained from a GPIO interface or a debug port system. The signal state enables an assistance system to judge a yellow light and a pedestrian signal light. The processor 123 is configured to implement the methods provided in the embodiments of the present application.

In this embodiment, the traffic road section may be a road section between two traffic lights. The vehicle may be a vehicle running in a traffic road section. The first running state information may include related information such as speed, distance, and position of a vehicle. The associated assistance system may be another assistance system disposed in the same traffic road section as the assistance system. The second running state information may be related information such as speed, distance, and position of a vehicle (vehicle in the traffic road section) determined by the associated assistance system.

Illustratively, a lidar pan angle refers to the coverage in the horizontal direction of a lidar electromagnetic wave, which is limited; and a lidar tilt angle refers to the coverage in the vertical direction of a lidar electromagnetic wave, which is also limited. That is, the horizontal directional FOV and vertical directional FOV of a lidar are limited. The present application covers dynamic occlusion and static occlusion, so it is feasible to deploy an assistance system with a lower vertical height on the traffic light at the entrance of the road section (the start of the road section) and deploy an associated assistance system with a higher vertical height on the traffic light at the tail of the road section (the end of the road section). The intelligent traffic assistance system with a lower vertical height is configured to receive the ID of a user of the intelligent traffic assistance system, allocate lidar channels with different frequency bands to the user, and determine the vehicle accommodation information of the road section at a yellow light. The intelligent traffic assistance system with a higher vertical height is configured to assist in detecting the vehicle accommodation information of the road section and provide a larger FOV and a larger LOS at a higher position to avoid lidar detection dead angle caused by dynamic occlusion arising from occlusion of a large vehicle.

Illustratively, the assistance system/associated assistance system may continuously emit lidar waves to detect vehicles in the traffic road section; determine, based on echoes, the first running state information and the second running state information of vehicles in the traffic road section, where the first running state information and the second running state information are detected by a lidar; and acquire the second running state information of vehicles in the traffic road section by using the corresponding communication channel (such as a Zigbee radio frequency module), where the second running state information is transmitted by the associated assistance system.

In S120, if an associated signal indicator light satisfies an information determination condition, road section information of the traffic road section is determined based on the first running state information, the second running state information, and preset road section attribute information.

In this embodiment, the associated signal indicator light may be a traffic light for determining whether to determine the road section information. The information determination condition may be a signal indicator light condition such as a red light or a yellow light and so on. The road section information may be information including the vehicle accommodation information and the time length taking for vehicles waiting at a red light to fully occupy the traffic road section. The road section attribute information may include road section information including the length of the road section, the maximum speed limit value of the road section and so on.

Illustratively, since the assistance system is directly connected to the signal indicator light, the processor can acquire the indicator signal of the signal indicator light disposed at the end of the traffic road section. That is, the signal indicator light disposed at the end of the traffic road section serves as the associated indicator light. The signal indicator light disposed at the next crossing may also serve as the associated indicator light. In an embodiment, when the indicator signal of the associated signal indicator light of the traffic road section is yellow, the processor may determine that the information determination condition is satisfied. In another embodiment, when the indicator signal of the signal indicator light at the next crossing is red (that is, it can be known from the association between signal indicator lights that the signal indicator light of the traffic road section is about to turn yellow), the processor may determine that the information condition is satisfied. The processor may determine running information of all vehicles in the traffic road section based on the first running state information and the second running state information; determine the distance between the last vehicle in each lane of the traffic road section and the tail end of the traffic road section based on information including vehicle speed, distance, road section length, and the maximum speed limit; determine the vehicle accommodation information of the traffic road section and the time length taking for vehicles waiting at a red light to fully occupy the traffic road section; and determine the vehicle accommodation information of the traffic road section and the time length taking for vehicles waiting at a red light to fully occupy the traffic road section as the road section information of the traffic road section. Here the vehicle accommodation information indicates the number of vehicles (other than vehicles that have already entered the traffic road section) that can be accommodated by the traffic road section, and the time length taking for vehicles waiting at a red light to fully occupy the traffic road section indicates the time length that takes for vehicles to fully park the traffic road section. The vehicle accommodation information and the time length taking for vehicles waiting at a red light to fully occupy the traffic road section may be determined by the assistance system, may be determined by the associated assistance system, or may be determined by the assistance system and the associated assistance system respectively. This is not limited by the present application.

In S130, the road section information is sent to the assistance vehicle corresponding to the assistance system.

In this embodiment, the assistance vehicle may be construed as a vehicle that is associated with the assistance system and that has run to or has not run to the traffic road section.

Illustratively, the assistance system may send the road section information to the corresponding assistance vehicle through the set broadcast module and broadcast antenna module.

The preceding solution includes acquiring, by an assistance system, first running state information of a vehicle in a traffic road section and acquiring second running state information transmitted by an associated assistance system in the traffic road section; in response to an associated signal indicator light satisfying an information determination condition, determining road section information of the traffic road section based on the first running state information, the second running state information, and preset road section attribute information; and sending the road section information to an assistance vehicle corresponding to the assistance system. Lidars in the assistance system and the associated assistance system both acquire running state information. Vehicle accommodation information of the traffic road section and the time length taking for vehicles waiting at a red light to fully occupy the traffic road section are determined using the two pieces of running state information. Then the road section information is sent to the assistance vehicle. In this manner, the road section information can be determined automatically and accurately so that information inaccuracy caused by dynamic occlusion is solved.

In a first alternative embodiment of this embodiment, based on the previous embodiment, the method also includes allocating lidar channels to associated vehicles in the traffic road section and determining lidar channel information of the associated vehicles.

A lidar channel may be construed as a channel configured in a lidar system to receive and send a lidar echo signal. An associated vehicle may be a vehicle associated with the assistance system, that is, a vehicle that can receive information transmitted by the assistance system. Lidar channel information may be information for determining a lidar channel corresponding to an associated vehicle.

Illustratively, the assistance system may allocate the lidar channels to the associated vehicles in the traffic road section in a FIFO manner based on the number of lidar channels and the entry sequence of the associated vehicles in the traffic road section; and establish association information between the lidar channels and the allocated associated vehicles to determine the lidar channel information of the associated vehicles. The step of determining the lidar channel information of the associated vehicles may be determining the lidar channel information of the associated vehicles by using the assistance system disposed at the start position of the traffic road section. And the first running state information and the second running state information may be sent to the associated vehicles in the traffic road section by using the lidar channel information.

Further, based on the previous embodiment, allocating the lidar channels to the associated vehicles in the traffic road section to determine the lidar channel information of the associated vehicles includes steps A1, B1, C1, D1, and E1.

In A1, a first entry sequence of the associated vehicles in the traffic road section is acquired.

In this embodiment, the first entry sequence may be the sequence in which vehicles enter the traffic road section.

Illustratively, the processor may record the entry sequence of the associated vehicles in the traffic road section to obtain the first entry sequence of the associated vehicles in the traffic road section.

In B1, the associated vehicles are divided into target vehicles satisfying an allocation condition and to-be-allocated vehicles based on the first entry sequence and a preset number of lidar channels, and a second entry sequence of the to-be-allocated vehicles is determined.

In this embodiment, the preset number of lidar channels may be the number of lidar channels provided by a lidar. A target vehicle may be a vehicle to which a lidar channel can be allocated currently. A to-be-allocated vehicle may be a vehicle to which no lidar channel can be allocated currently. The second entry sequence may be the entry sequence of the to-be-allocated vehicles. That is, the first entry sequence excludes the entry sequence of the target vehicles.

Illustratively, the assistance system may determine the same number of vehicles in the first sequence as the preset number of lidar channels to be target vehicles based on the first entry sequence and the preset number of lidar channels; determine the remaining vehicles among the associated vehicles as the to-be-allocated vehicles; and remove the target vehicles from the first entry sequence to obtain a second entry sequence of the to-be-allocated vehicles.

In C1, first lidar channel information of the target vehicles is determined based on the first entry sequence.

In this embodiment, the first lidar channel information may be information indicating an association between the target vehicles and the lidar channels.

Illustratively, the assistance system may sequentially allocate the lidar channels to the target vehicles according to the first entry sequence to establish the association between the target vehicles and the lidar channels to obtain the first lidar channel information of the target vehicles.

Illustratively, it is assumed that the preset number of lidar channels is 5, and the first entry sequence is vehicle A, vehicle B, vehicle D, vehicle C, vehicle E, vehicle F, vehicle G, and vehicle H. Under this assumption, vehicle A, vehicle B, vehicle D, vehicle C, and vehicle E serve as target vehicles. Vehicle A is the first to arrive at the traffic road section and send its vehicle ID to the assistance system, so vehicle A is allocated lidar channel 1. According to the first entry sequence, vehicle B, vehicle D, vehicle C, and vehicle E are allocated lidar channel 2, allocated lidar channel 3, allocated lidar channel 4, and allocated lidar channel 5 respectively. The first lidar channel information indicates that the vehicle ID of vehicle A is associated with lidar channel 1, the vehicle ID of vehicle B is associated with lidar channel 2, and so on. Vehicle F, vehicle G, and vehicle H serve as to-be-allocated vehicles. The second entry sequence is vehicle F, vehicle G, and vehicle H.

In D1, when the target vehicles exit the traffic road section, the second lidar channel information of the to-be-allocated vehicles is determined based on the second entry sequence.

In this embodiment, the second lidar channel information may be information for associating the to-be-allocated vehicles with the lidar channels.

Illustratively, when a target vehicle exits the traffic road section (when the tail end of a vehicle leaves the exit line, the vehicle is considered to exit the traffic road section), the assistance system may allocate a lidar channel corresponding to the target vehicle to the to-be-allocated vehicle according to the second entry sequence.

Illustratively, as described in the previous example, when vehicle A exits the traffic road section, vehicle F in the second entry sequence is the first, and lidar channel 1 corresponding to vehicle A may be allocated to vehicle F, that is, the second lidar channel information of vehicle F is that the vehicle ID of vehicle F is associated with channel 1. Similarly, the lidar channel allocated to the other vehicles in the second entry sequence may be determined in the same manner.

In E1, the first lidar channel information and the second lidar channel information are determined as the lidar channel information.

Illustratively, the assistance system may send the first lidar channel information and the second lidar channel information as the lidar channel information to the associated assistance system in the traffic road section so that the associated assistance system can send the first running state information, the second running state information, and the road section information to the associated vehicles based on the lidar channel information.

Further, in an embodiment, based on the previous embodiment, determining the associated vehicles includes steps A2 and B2.

In A2, whether a to-be-determined vehicle in the traffic road section is provided with a lidar electronic tag is determined by using emitted lidar radio waves.

The lidar waves may be lidar waves for detecting whether a vehicle has a lidar electronic tag. The to-be-determined vehicle may be a vehicle running in the traffic road section. The lidar electronic tag may be a tag for indicating an association with the assistance system.

Illustratively, the assistance system may emit lidar waves and determine, based on the lidar waves, whether a to-be-determined vehicle running in the traffic road section is provided with a lidar electronic tag.

In B2, in response to determining that the to-be-determined vehicle is provided with the lidar electronic tag, the vehicle ID of the to-be-determined vehicle is acquired, and the to-be-determined vehicle is determined as an associated vehicle.

In this embodiment, vehicle ID of a vehicle may be a unique ID for indicating the vehicle.

Illustratively, in response to determining that the to-be-determined vehicle is provided with the lidar electronic tag, the assistance system may receive the vehicle ID of the to-be-determined vehicle, record the vehicle ID, and determine the to-be-determined vehicle as an associated vehicle.

In the first alternative embodiment of this embodiment, lidar channels can be allocated automatically, mutual interference between lidars can be avoided, and associated vehicles can be determined automatically.

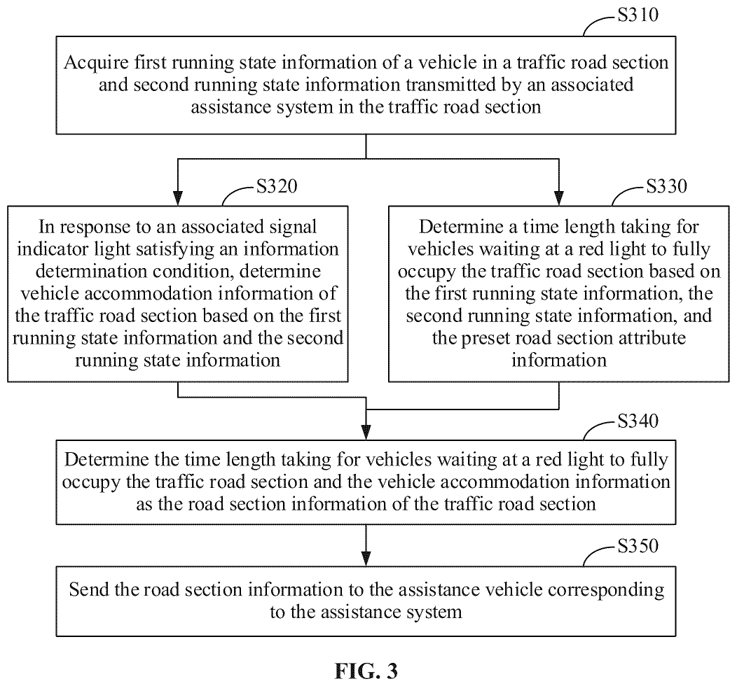

FIG. 3 is a flowchart of a road section information determination method according to an embodiment of the present application. This embodiment is refined based on the previous embodiment. As shown in FIG. 3, the method includes steps S310, S320, S330, S340, and S350.

In S310, first running state information of a vehicle in a traffic road section and second running state information transmitted by an associated assistance system in the traffic road section are acquired.

In S320, in response to an associated signal indicator light satisfying an information determination condition, vehicle accommodation information of the traffic road section is determined based on the first running state information and the second running state information.

In this embodiment, the vehicle accommodation information may be vehicle number information that indicates the number of vehicles (other than vehicles that have already entered the traffic road section) that can enter all lanes of the traffic road section.

Illustratively, the assistance system may determine vehicle positions of each lane in the traffic road section based on the first running state information and the second running state information in response to an associated signal indicator light satisfying an information determination condition, determine the distance from the end vehicle in each lane to the start line based on the position of the end vehicle closest to the start line of the traffic road section and then determine the vehicle accommodation information of the road section.

Further, based on the previous embodiment, determining the vehicle accommodation information of the traffic road section based on the first running state information and the second running state information includes steps A3, B3, and C3.

In A3, a first target vehicle in each lane of the traffic road section is determined based on the first running state information and the second running state information.

In this embodiment, the first target vehicle may be the last vehicle in each lane. Each lane may be a lane obtained by division by a lane line.

Illustratively, the assistance system may determine the position of each vehicle in each lane of the traffic road section based on vehicle positions in the first running state information and the second running state information and determine the first target vehicle in each lane of the traffic road section and adjacent to the start of the traffic road section.

In B3, the distance between each first target vehicle and a preset road section start reference line is determined so that first distance information of a corresponding lane is obtained.

In this embodiment, the road section start reference line may be a reference line drawn at the start position of the traffic road section. The first distance information may be the distance from the first target vehicle in each lane to the road section start reference line.

Illustratively, the assistance system may acquire the position of the preset road section start reference line from the corresponding storage medium and determine the first distance information between each first target vehicle and the road section start reference line.

In C3, the vehicle accommodation information of the traffic road section is determined based on the first distance information.

Illustratively, the assistance system may determine the number of vehicles that can be accommodated by each lane based on information including each of the first distance information and a preset general vehicle length. For example, the number of vehicles may be obtained by dividing the first distance information by the general vehicle length, and the number of vehicles that can be accommodated by all lanes of the road section is used as the vehicle accommodation information of the traffic road section. If the traffic road section can accommodate no more vehicles, no vehicle accommodation space of the traffic road section is used as the vehicle accommodation information of the traffic road section.

In S330, a time length taking for vehicles waiting at a red light to fully occupy the traffic road section is determined based on the first running state information, the second running state information, and the preset road section attribute information.

In this embodiment, the time length taking for vehicles waiting at a red light to fully occupy the traffic road section may be the time length taking for the vehicles to fully park all lanes from the start position of the traffic road section to the end position of the traffic road section.

Illustratively, the assistance system may determine the distance of the space where no vehicle is parked in the road section based on the first running state information, the second running state information, and the preset road section attribute information and determine the time length taking for vehicles waiting at a red light to fully occupy the traffic road section according to the distance of the space where no vehicle is parked in the road section in conjunction with the maximum speed limit value in the road section attribute information.

Further, based on the previous embodiment, determining the time length taking for vehicles waiting at a red light to fully occupy the traffic road section based on the first running state information, the second running state information, and the preset road section attribute information includes steps A4, B4, and C4.

In A4, the total number of vehicles in the traffic road section and a second target vehicle in each lane of the traffic road section are determined based on the first running state information and the second running state information.

In this embodiment, the total number of vehicles may be the number of vehicles contained in the traffic road section. The second target vehicle may be the vehicle at the foremost end of each lane, that is, closest to the end position of the traffic road section.

Illustratively, the assistance system may determine the total number of vehicles in the traffic road section and the second target vehicle located in each lane and closest to the end position of the traffic road section based on the number of pieces of the first running state information and the second running state information and the vehicle position information of the road section in the first running state information and the second running state information.

In B4, the distance between each second target vehicle and a preset road section end reference line is determined so that second distance information of a respective lane is obtained.

In this embodiment, the road section end reference line may be a reference line drawn at the end position of the traffic road section. The second distance information may be the distance between the second target vehicle in each lane and the road section end reference line.

Illustratively, the assistance system may acquire the position of the preset road section end reference line from the corresponding storage medium and determine the second distance information between each second target vehicle and the road section end reference line.

In C4, the time length taking for vehicles waiting at a red light to fully occupy the traffic road section is determined based on the total number of vehicles, the preset road section attribute information, and the second distance information.

Illustratively, the assistance system may determine the time length taking for vehicles waiting at a red light to fully occupy the traffic road section based on the total number of vehicles, the road section length value, the number of lanes, the second distance information, and the maximum speed limit value in the preset road section attribute information by using a corresponding calculation mode.

Illustratively, it is assumed that X (meter) indicates the value of length between the road section start reference line and the road section end reference line; the road section is divided into three lanes; Y indicates the second distance information, where Y=Y1+Y2+Y3, where Y1, Y2, and Y3 indicate the respective second distances of the three lanes; U indicates the total number of vehicles; and the interval between each two vehicles is at least one meter. Thus, it is estimated that the intervals between the U vehicles are (U−1) in total. Thus, {[(3*X)−Y−(U−1)]/The maximum speed limit value V of the road section}=S, where S indicates the time length taking for vehicles waiting at a red light to fully occupy the traffic road section, that is, the road section is fully parked by vehicles within S seconds. Vehicles may be running, so both the received first running state information and second running state information and S vary with time.

In S340, the time length taking for vehicles waiting at a red light to fully occupy the traffic road section and the vehicle accommodation information are determined as the road section information of the traffic road section.

Illustratively, the assistance system may determine the time length taking for vehicles waiting at a red light to fully occupy the traffic road section and the vehicle accommodation information as the road section information of the traffic road section.

In S350, the road section information is sent to the assistance vehicle corresponding to the assistance system.

In the solution of this embodiment of the present application, first running state information of a vehicle in a traffic road section and second running state information transmitted by an associated assistance system in the traffic road section are acquired by an assistance system and an associated assistance system disposed at different positions and with different vertical heights; in response to an associated signal indicator light satisfying an information determination condition, the time length taking for vehicles waiting at a red light to fully occupy the traffic road section is determined based on the first running state information, the second running state information, and preset road section attribute information; vehicle accommodation information is determined based on the first running state information and the second running state information; and the road section information including the vehicle accommodation information and the time length taking for vehicles waiting at a red light to fully occupy the traffic road section is sent to the assistance vehicle corresponding to the assistance system. In this manner, the road section information can be determined automatically and accurately so that the time length taking for vehicles waiting at a red light to fully occupy the traffic road section can be determined and information inaccuracy caused by dynamic occlusion is solved.

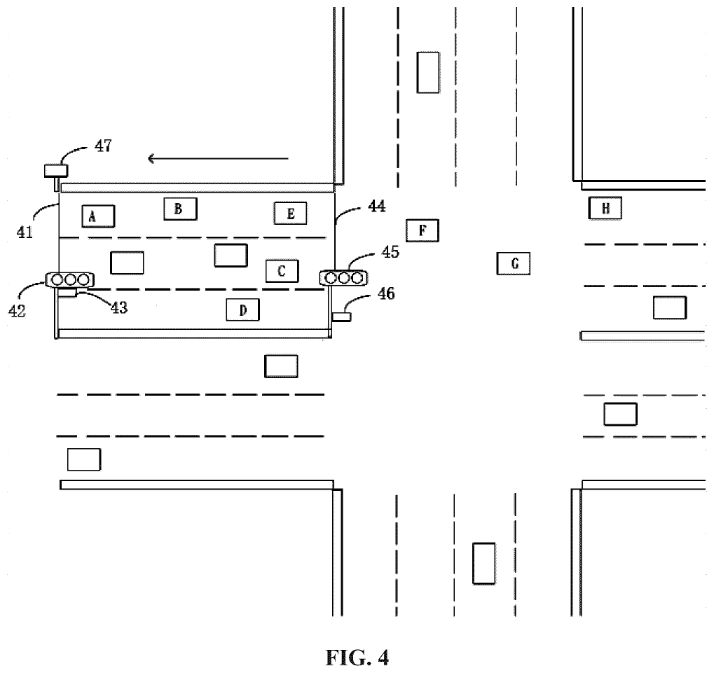

Illustratively, to facilitate understanding of the present application, a traffic road section is used as an example. FIG. 4 is a diagram illustrating a traffic road section of a road section information determination method according to an embodiment of the present application. As shown in FIG. 4, 41 indicates a road section end reference line; 42 indicates an associated signal indicator light at the end of the road section, and 42 is disposed at an assistance system 43 at a first traffic light to guide vehicle traffic of an associated road section; 44 indicates a road section start reference line; 45 indicates a signal indicator light at the start of the road section, and 45 is disposed at an assistance system 46 at a second traffic light; A, B, C, D, E, F, G and H are associated vehicles, and F, G and H are assistance vehicles; 41 and 44 constitute the traffic road section; 47 indicates an associated signal indicator light; a rectangle not marked by a letter in the traffic road section is a common vehicle not associated with an assistance system; the traffic road section includes three lanes; and the arrow indicates the running direction of a vehicle. As can be seen from the drawing, the associated signal indicator light 42 at the end of the road section is provided with the assistance system 43 having a larger vertical height, and the signal indicator light 45 at the start of the road section is provided with the associated assistance system 46 having a lower vertical height. The assistance system 43 is disposed in a larger vertical height and thus provides a larger FOV and a larger LOS. This avoids lidar detection dead angle caused by dynamic occlusion arising from occlusion of a large vehicle. Thus, the assistance system 43 can determine the time length taking for vehicles waiting at a red light to fully occupy the traffic road section. The frequency band available to a lidar is limited and thus the associated assistance system 46 is configured to have a low vertical height. Therefore, the associated assistance system 46 assigns lidar channel information to an associated vehicle to avoid the problem of mutual interference between lidars, and the associated assistance system 46 determines the vehicle accommodation information.

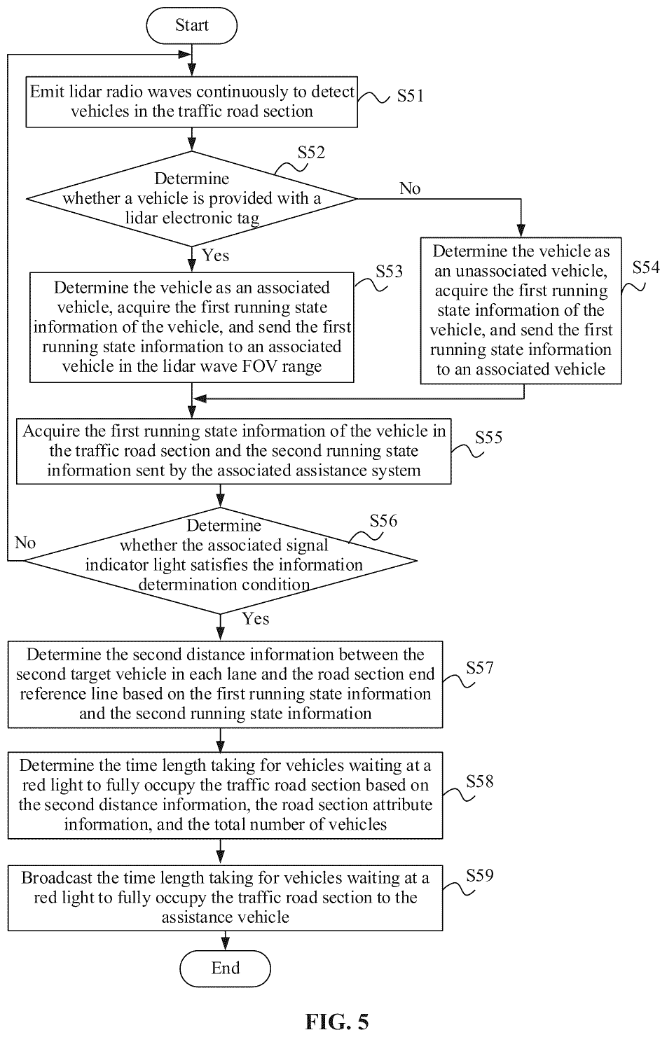

Based on the preceding example description, the step of determining the vehicle accommodation information by the associated assistance system 46 and the step of determining the time length taking for vehicles waiting at a red light to fully occupy the traffic road section by the assistance system 43 are described. FIG. 5 is an example flowchart of a road section information determination method according to an embodiment of the present application. As shown in FIG. 5, the step of determining the time length taking for vehicles waiting at a red light to fully occupy the traffic road section by the assistance system 43 may include steps S51, S52, S53, S54, S55, S56, S57, S58, and S59.

In S51, lidar radio waves are continuously emitted to detect vehicles in the traffic road section.

In S52, whether a vehicle is provided with a lidar electronic tag is determined; if the vehicle is provided with a lidar electronic tag, S53 is performed; and if the vehicle is provided with no lidar electronic tag, S54 is performed.

In S53, the vehicle with a lidar electronic tag is determined as an associated vehicle, and the first running state information of the vehicle is acquired and sent to an associated vehicle in the lidar wave FOV range.

In S54, the vehicle without a lidar electronic tag is determined as an unassociated vehicle, and the first running state information of the vehicle is acquired and sent to an associated vehicle.

In S55, the first running state information of the vehicle in the traffic road section and the second running state information sent by the associated assistance system are acquired.

In S56, it is determined whether the associated signal indicator light satisfies the information determination condition; if the associated signal indicator light satisfies the information determination condition, S57 is performed; and if the associated signal indicator light does not satisfy the information determination condition, S51 is performed.

In S57, the second distance information between the second target vehicle in each lane and the road section end reference line is determined based on the first running state information and the second running state information.

In S58, the time length taking for vehicles waiting at a red light to fully occupy the traffic road section is determined based on the second distance information, the road section attribute information, and the total number of vehicles.

In S59, the time length taking for vehicles waiting at a red light to fully occupy the traffic road section is broadcast to the assistance vehicle.

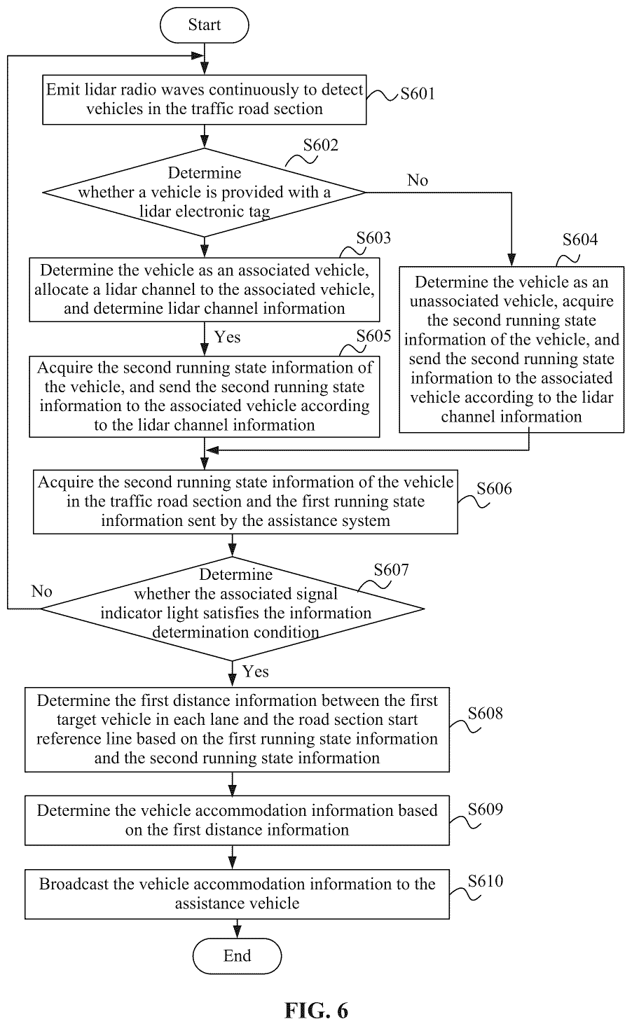

Based on the preceding example description, FIG. 6 is another example flowchart of a road section information determination method according to an embodiment of the present application. As shown in FIG. 6, the step in which the associated assistance system 46 determines the vehicle accommodation information may include steps S601, S602, S603, S604, S605, S606, S607, S608, S609, and S610.

In S601, lidar radio waves are continuously emitted to detect vehicles in the traffic road section.

In S602, whether a vehicle is provided with a lidar electronic tag is determined; if the vehicle is provided with a lidar electronic tag, S603 is performed; and if the vehicle is provided with no lidar electronic tag, S604 is performed.

In S603, the vehicle with a lidar electronic tag is determined as an associated vehicle, a lidar channel is allocated to the associated vehicle, and lidar channel information is determined.

In S604, the vehicle without a lidar electronic tag is determined as an unassociated vehicle, the second running state information of the vehicle without a lidar electronic tag is acquired, and the second running state information is sent to the associated vehicle according to the lidar channel information of the associated vehicle.

In S605, the second running state information of the vehicle with a lidar electronic tag is acquired, and the second running state information is sent to the associated vehicle according to the lidar channel information of the associated vehicle.

In S606, the second running state information of the vehicle in the traffic road section and the first running state information sent by the assistance system are acquired.

In S607, whether the associated signal indicator light satisfies the information determination condition is determined; if the associated signal indicator light satisfies the information determination condition, S608 is performed; and if the associated signal indicator light does not satisfy the information determination condition, S601 is performed.

In S608, the first distance information between the first target vehicle in each lane and the road section start reference line is determined based on the first running state information and the second running state information.

In S609, the vehicle accommodation information is determined based on the first distance information.

In S610, the vehicle accommodation information is broadcast to the assistance vehicle.

FIG. 7 is a diagram illustrating the structure of a road section information determination apparatus according to an embodiment of the present application. As shown in FIG. 7, the apparatus includes an information acquisition module 71, an information determination module 72, and an information sending module 73.

The information acquisition module 71 is configured to acquire first running state information of a vehicle in a traffic road section and second running state information transmitted by an associated assistance system in the traffic road section.

The information determination module 72 is configured to, in response to an associated signal indicator light satisfying an information determination condition, determine road section information of the traffic road section based on the first running state information, the second running state information, and preset road section attribute information.

The information sending module 73 is configured to send the road section information to an assistance vehicle corresponding to the assistance system.

The preceding solution includes acquiring, by an assistance system, first running state information of a vehicle in a traffic road section and acquiring second running state information transmitted by an associated assistance system in the traffic road section; in response to an associated signal indicator light satisfying an information determination condition, determining road section information of the traffic road section based on the first running state information, the second running state information, and preset road section attribute information; and sending the road section information to an assistance vehicle corresponding to the assistance system. Lidars in the assistance system and the associated assistance system both acquire running state information. Vehicle accommodation information of the traffic road section and the time length taking for vehicles waiting at a red light to fully occupy the traffic road section are determined using the two pieces of running state information. Then the road section information is sent to the assistance vehicle. In this manner, the road section information can be determined automatically and accurately so that information inaccuracy caused by dynamic occlusion is solved.

Further, the information determination module includes a first determination unit, a second determination unit, and a third determination unit.

The first determination unit is configured to determine vehicle accommodation information of the traffic road section based on the first running state information and the second running state information.

The second determination unit is configured to determine a time length taking for vehicles waiting at a red light to fully occupy the traffic road section based on the first running state information, the second running state information, and the preset road section attribute information.

The third determination unit is configured to determine the time length taking for vehicles waiting at a red light to fully occupy the traffic road section and the vehicle accommodation information as the road section information of the traffic road section.

The first determination unit is configured to determine a first target vehicle in each lane of the traffic road section based on the first running state information and the second running state information; determine a distance between each first target vehicle and a preset road section start reference line to obtain first distance information of a respective lane; and determine the vehicle accommodation information of the traffic road section based on each piece of the first distance information.

The second determination unit is configured to determine the total number of vehicles in the traffic road section and a second target vehicle in each lane of the traffic road section based on the first running state information and the second running state information; determine the distance between each second target vehicle and a preset road section end reference line to obtain second distance information of a respective lane; and determine the time length taking for vehicles waiting at a red light to fully occupy the traffic road section based on the total number of vehicles, the preset road section attribute information, and each piece of the second distance information.

Alternatively, the apparatus also includes a channel determination module.

The channel determination module is configured to allocate lidar channels to associated vehicles in the traffic road section and determine lidar channel information of the associated vehicles.

The channel determination module is configured to acquire a first entry sequence of the associated vehicles in the traffic road section; divide the associated vehicles into target vehicles satisfying an allocation condition and to-be-allocated vehicles based on the first entry sequence and the preset number of lidar channels and determine a second entry sequence of the to-be-allocated vehicles; determine first lidar channel information of the target vehicles based on the first entry sequence; determine second lidar channel information of a to-be-allocated vehicle of the to-be-allocated vehicles based on the second entry sequence when a target vehicle of the target vehicles exits the traffic road section; and determine the first lidar channel information and the second lidar channel information as the lidar channel information.

Alternatively, the apparatus also includes a vehicle determination module.

The vehicle determination module is configured to determine, by using emitted lidar radio waves, whether a to-be-determined vehicle in the traffic road section is provided with a lidar electronic tag; and in response to determining that the to-be-determined vehicle is provided with a lidar electronic tag, acquire the vehicle identifier of the to-be-determined vehicle and determine the to-be-determined vehicle as an associated vehicle.

The road section information determination apparatus of this embodiment of the present application can perform the road section information determination method of any embodiment of the present application and has function modules and beneficial effects corresponding to the performed method.

### Embodiment Four

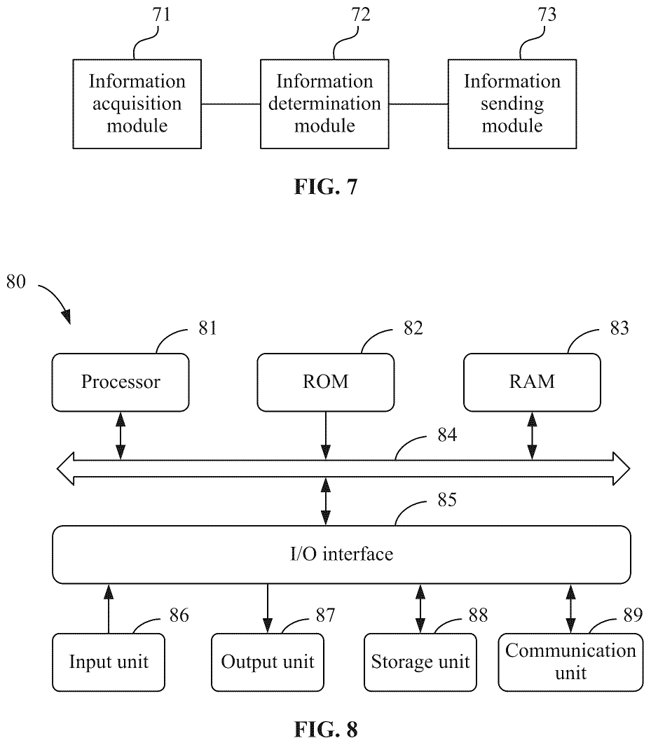

FIG. 8 is a diagram illustrating the structure of an electronic device 80 for implementing any embodiment of the present application. The electronic device is intended to represent various forms of digital computers, for example, a laptop computer, a desktop computer, a worktable, a personal digital assistant, a server, a blade server, a mainframe computer, or an applicable computer. The electronic device may also represent various forms of mobile apparatuses, for example, a personal digital assistant, a cellphone, a smartphone, a wearable device (such as a helmet, glasses, and a watch), or a similar computing apparatus. Herein the shown components, the connections and relationships between these components, and the functions of these components are illustrative only and are not intended to limit the implementation of the present application as described and/or claimed herein.

As shown in FIG. 8, the electronic device 80 includes at least one processor 81 and a memory (such as a read-only memory (ROM) 82 and a random-access memory (RAM) 83) communicatively connected to the at least one processor 81. The memory stores a computer program executable by the at least one processor. A processor 81 may perform various types of appropriate operations and processing according to a computer program stored in a ROM 82 or a computer program loaded from a storage unit 88 to a RAM 83. Various programs and data required for the operation of the electronic device 80 may also be stored in the RAM 83. The processor 81, the ROM 82, and the RAM 83 are connected to each other through a bus 84. An input/output (I/O) interface 85 is also connected to the bus 84.

Multiple components in the electronic device 80 are connected to the I/O interface 85. The multiple components include an input unit 86 such as a keyboard or a mouse, an output unit 87 such as various types of display or speaker, the storage unit 88 such as a magnetic disk or an optical disk, and a communication unit 89 such as a network card, a modem, or a wireless communication transceiver. The communication unit 89 allows the electronic device 80 to exchange information/data with other devices over a computer network such as the Internet and/or various telecommunications networks.

The processor 81 may be various general-purpose and/or special-purpose processing components having processing and computing capabilities. Examples of the processor 81 include, but are not limited to, a central processing unit (CPU), a graphics processing unit (GPU), a special-purpose artificial intelligence (AI) computing chip, a processor executing machine learning models and algorithms, a digital signal processor (DSP), and any appropriate processor, controller and microcontroller. The processor 81 performs various preceding methods and processing, such as the road section information determination method.

In some examples, the road section information determination method may be implemented as computer programs tangibly contained in a computer-readable storage medium such as the storage unit 88. In some embodiments, part or all of computer programs may be loaded and/or installed onto the electronic device 80 via the ROM 82 and/or the communication unit 89. When the computer programs are loaded to the RAM 83 and executed by the at least one processor 81, one or more steps of the preceding road section information determination method may be performed. Alternatively, in other embodiments, the at least one processor 81 may be configured, in any other suitable manner (for example, by means of firmware), to perform the road section information determination method.

Herein various embodiments of the systems and techniques described above may be implemented in digital electronic circuitry, integrated circuitry, field-programmable gate arrays (FPGAs), application-specific integrated circuits (ASICs), application-specific standard products (ASSPs), systems on chips (SOCs), complex programmable logic devices (CPLDs), computer hardware, firmware, software, and/or combinations thereof. The various embodiments may include implementations in one or more computer programs. The one or more computer programs are executable and/or interpretable on a programmable system including at least one programmable processor. The programmable processor may be a special-purpose or general-purpose programmable processor for receiving data and instructions from a memory system, at least one input apparatus, and at least one output apparatus and transmitting data and instructions to the memory system, the at least one input apparatus, and the at least one output apparatus.

Computer programs for implementation of the methods of the present application may be written in one programming language or any combination of multiple programming languages. These computer programs may be provided for a processor of a general-purpose computer, a special-purpose computer or another programmable data processing apparatus such that the computer programs, when executed by the processor, cause functions/operations specified in the flowcharts and/or block diagrams to be implemented. These computer programs may be executed entirely on a machine, partly on a machine, as a stand-alone software package, partly on a machine and partly on a remote machine, or entirely on a remote machine or a server.

In the context of the present disclosure, the computer-readable storage medium may be a tangible medium including or storing a computer program that is used by or used in conjunction with an instruction execution system, apparatus or device. The computer-readable storage medium may include, but is not limited to, an electronic, magnetic, optical, electromagnetic, infrared or semiconductor system, apparatus or device, or any suitable combination thereof. Alternatively, the computer-readable storage medium may be a machine-readable signal medium. Concrete examples of the machine-readable storage medium include an electrical connection based on one or more wires, a portable computer disk, a hard disk, a RAM, a ROM, an erasable programmable read-only memory (EPROM), a flash memory, an optical fiber, a portable compact disc read-only memory (CD-ROM), an optical storage device, a magnetic storage device, or any appropriate combination thereof.

In order that interaction with a user is provided, the systems and techniques described herein may be implemented on the electronic device. The electronic device has a display device (for example, a cathode-ray tube (CRT) or a liquid-crystal display (LCD) monitor) for displaying information to the user; and a keyboard and a pointing device (for example, a mouse or a trackball) through which the user can provide input for the electronic device. Other types of apparatuses may also be used for providing interaction with a user. For example, feedback provided for the user may be sensory feedback in any form (for example, visual feedback, auditory feedback, or tactile feedback); and input from the user may be received in any form (including acoustic input, voice input, or tactile input).

The systems and techniques described herein may be implemented in a computing system including a back-end component (for example, a data server), a computing system including a middleware component (for example, an application server), a computing system including a front-end component (for example, a user computer having a graphical user interface or a web browser through which a user can interact with embodiments of the systems and techniques described herein), or a computing system including any combination of such back-end, middleware, or front-end components. Components of a system may be interconnected by any form or medium of digital data communication (for example, a communication network). Examples of the communication network include a local area network (LAN), a wide area network (WAN), a blockchain network, and the Internet.

The computing system may include clients and servers. A client and a server are generally remote from each other and typically interact through a communication network. The relationship between the client and the server arises by virtue of computer programs running on respective computers and having a client-server relationship to each other. The server may be a cloud server, also referred to as a cloud computing server or a cloud host. As a host product in a cloud computing service system, the server solves the defects of difficult management and weak service scalability in a related physical host and a related virtual private server (VPS).

It is to be understood that various forms of the preceding flows may be used with steps reordered, added, or deleted. For example, the steps described in the present disclosure may be performed in parallel, in sequence, or in a different order as long as the desired result of the technical solutions provided in the present disclosure can be achieved. The execution sequence of these steps is not limited herein.

The scope of the present disclosure is not limited to the preceding embodiments. It is to be understood by those skilled in the art that various modifications, combinations, subcombinations, and substitutions may be made according to design requirements and other factors. Any modification, equivalent substitution, improvement, and the like made within the spirit and principle of the present disclosure fall within the scope of the present disclosure.

What is claimed is:

1. A road section information determination method, the method being applied to an assistance system and comprising:
acquiring first running state information of a vehicle in a traffic road section and second running state information transmitted by an associated assistance system in the traffic road section;
in response to an associated signal indicator light satisfying an information determination condition, determining road section information of the traffic road section based on the first running state information, the second running state information, and preset road section attribute information; and
sending the road section information to an assistance vehicle corresponding to the assistance system.

2. The method of claim 1, wherein determining the road section information of the traffic road section based on the first running state information, the second running state information, and the preset road section attribute information comprises:
determining vehicle accommodation information of the traffic road section based on the first running state information and the second running state information;
determining a time length taking for vehicles waiting at a red light to fully occupy the traffic road section based on the first running state information, the second running state information, and the preset road section attribute information; and
determining the time length taking for vehicles waiting at a red light to fully occupy the traffic road section and the vehicle accommodation information as the road section information of the traffic road section.

3. The method of claim 2, wherein determining the vehicle accommodation information of the traffic road section based on the first running state information and the second running state information comprises:
determining a first target vehicle in each lane of the traffic road section based on the first running state information and the second running state information;
determining a distance between the first target vehicle in each lane and a preset road section start reference line to obtain first distance information of a respective lane; and
determining the vehicle accommodation information of the traffic road section based on the first distance information of each lane.

4. The method of claim 2, wherein determining the time length taking for vehicles waiting at a red light to fully occupy the traffic road section based on the first running state information, the second running state information, and the preset road section attribute information comprises:
determining a total number of vehicles in the traffic road section and a second target vehicle in each lane of the traffic road section based on the first running state information and the second running state information;
determining a distance between the second target vehicle in each lane and a preset road section end reference line to obtain second distance information of a respective lane; and
determining the time length taking for vehicles waiting at a red light to fully occupy the traffic road section based on the total number of vehicles, the preset road section attribute information, and the second distance information of each lane.

5. The method of claim 1, further comprising:
allocating lidar channels to associated vehicles in the traffic road section and determining lidar channel information of the associated vehicles.

6. The method of claim 5, wherein allocating the lidar channels to the associated vehicles in the traffic road section and determining the lidar channel information of the associated vehicles comprises:
acquiring a first entry sequence of the associated vehicles in the traffic road section;
dividing the associated vehicles into target vehicles satisfying an allocation condition and to-be-allocated vehicles based on the first entry sequence and a preset number of lidar channels and determining a second entry sequence of the to-be-allocated vehicles;
determining first lidar channel information of the target vehicles based on the first entry sequence;
determining second lidar channel information of a to-be-allocated vehicle of the to-be-allocated vehicles based on the second entry sequence when a target vehicle of the target vehicles exits the traffic road section; and
determining the first lidar channel information and the second lidar channel information as the lidar channel information.

7. The method of claim 5, wherein the method further comprising determining the associated vehicles, wherein the determining the associated vehicles comprises:
determining, by using emitted lidar radio waves, whether a to-be-determined vehicle in the traffic road section is provided with a lidar electronic tag; and
in response to determining that the to-be-determined vehicle is provided with the lidar electronic tag, acquiring a vehicle identifier of the to-be-determined vehicle and determining the to-be-determined vehicle as an associated vehicle of the associated vehicles.

8. An electronic device, comprising:
at least one processor; and
a memory communicatively connected to the at least one processor,
wherein the memory stores a computer program executable by the at least one processor to enable the electronic device to perform a road section information determination method;
wherein the method comprising:
acquiring first running state information of a vehicle in a traffic road section and second running state information transmitted by an associated assistance system in the traffic road section;
in response to an associated signal indicator light satisfying an information determination condition, determining road section information of the traffic road section based on the first running state information, the second running state information, and preset road section attribute information; and
sending the road section information to an assistance vehicle corresponding to the assistance system.

9. The electronic device of claim 8, wherein determining the road section information of the traffic road section based on the first running state information, the second running state information, and the preset road section attribute information comprises:
determining vehicle accommodation information of the traffic road section based on the first running state information and the second running state information;
determining a time length taking for vehicles waiting at a red light to fully occupy the traffic road section based on the first running state information, the second running state information, and the preset road section attribute information; and
determining the time length taking for vehicles waiting at a red light to fully occupy the traffic road section and the vehicle accommodation information as the road section information of the traffic road section.

10. The electronic device of claim 9, wherein determining the vehicle accommodation information of the traffic road section based on the first running state information and the second running state information comprises:
determining a first target vehicle in each lane of the traffic road section based on the first running state information and the second running state information;
determining a distance between the first target vehicle in each lane and a preset road section start reference line to obtain first distance information of a respective lane; and
determining the vehicle accommodation information of the traffic road section based on the first distance information of each lane.

11. The electronic device of claim 9, wherein determining the time length taking for vehicles waiting at a red light to fully occupy the traffic road section based on the first running state information, the second running state information, and the preset road section attribute information comprises:
determining a total number of vehicles in the traffic road section and a second target vehicle in each lane of the traffic road section based on the first running state information and the second running state information;
determining a distance between the second target vehicle in each lane and a preset road section end reference line to obtain second distance information of a respective lane; and
determining the time length taking for vehicles waiting at a red light to fully occupy the traffic road section based on the total number of vehicles, the preset road section attribute information, and the second distance information of each lane.

12. The electronic device of claim 8, wherein the method further comprising:
allocating lidar channels to associated vehicles in the traffic road section and determining lidar channel information of the associated vehicles.

13. The electronic device of claim 12, wherein allocating the lidar channels to the associated vehicles in the traffic road section and determining the lidar channel information of the associated vehicles comprises:
acquiring a first entry sequence of the associated vehicles in the traffic road section;
dividing the associated vehicles into target vehicles satisfying an allocation condition and to-be-allocated vehicles based on the first entry sequence and a preset number of lidar channels and determining a second entry sequence of the to-be-allocated vehicles;
determining first lidar channel information of the target vehicles based on the first entry sequence;
determining second lidar channel information of a to-be-allocated vehicle of the to-be-allocated vehicles based on the second entry sequence when a target vehicle of the target vehicles exits the traffic road section; and
determining the first lidar channel information and the second lidar channel information as the lidar channel information.

14. The electronic device of claim 12, wherein the method further comprising determining the associated vehicles, wherein the determining the associated vehicles comprises:
determining, by using emitted lidar radio waves, whether a to-be-determined vehicle in the traffic road section is provided with a lidar electronic tag; and
in response to determining that the to-be-determined vehicle is provided with the lidar electronic tag, acquiring a vehicle identifier of the to-be-determined vehicle and determining the to-be-determined vehicle as an associated vehicle of the associated vehicles.

15. A non-transitory computer-readable storage medium storing computer instructions configured to, when executed, cause a processor to perform a road section information determination method;
wherein the method comprising:
acquiring first running state information of a vehicle in a traffic road section and second running state information transmitted by an associated assistance system in the traffic road section;
in response to an associated signal indicator light satisfying an information determination condition, determining road section information of the traffic road section based on the first running state information, the second running state information, and preset road section attribute information; and
sending the road section information to an assistance vehicle corresponding to the assistance system.

16. The non-transitory computer-readable storage medium of claim 15, wherein determining the road section information of the traffic road section based on the first running state information, the second running state information, and the preset road section attribute information comprises:
determining vehicle accommodation information of the traffic road section based on the first running state information and the second running state information;
determining a time length taking for vehicles waiting at a red light to fully occupy the traffic road section based on the first running state information, the second running state information, and the preset road section attribute information; and
determining the time length taking for vehicles waiting at a red light to fully occupy the traffic road section and the vehicle accommodation information as the road section information of the traffic road section.

17. The non-transitory computer-readable storage medium of claim 16, wherein determining the vehicle accommodation information of the traffic road section based on the first running state information and the second running state information comprises:
determining a first target vehicle in each lane of the traffic road section based on the first running state information and the second running state information;
determining a distance between the first target vehicle in each lane and a preset road section start reference line to obtain first distance information of a respective lane; and
determining the vehicle accommodation information of the traffic road section based on the first distance information of each lane.

18. The non-transitory computer-readable storage medium of claim 16, wherein determining the time length taking for vehicles waiting at a red light to fully occupy the traffic road section based on the first running state information, the second running state information, and the preset road section attribute information comprises:
determining a total number of vehicles in the traffic road section and a second target vehicle in each lane of the traffic road section based on the first running state information and the second running state information;
determining a distance between the second target vehicle in each lane and a preset road section end reference line to obtain second distance information of a respective lane; and
determining the time length taking for vehicles waiting at a red light to fully occupy the traffic road section based on the total number of vehicles, the preset road section attribute information, and the second distance information of each lane.

19. The non-transitory computer-readable storage medium of claim 15, wherein the method further comprising:
allocating lidar channels to associated vehicles in the traffic road section and determining lidar channel information of the associated vehicles.

20. The non-transitory computer-readable storage medium of claim 19, wherein allocating the lidar channels to the associated vehicles in the traffic road section and determining the lidar channel information of the associated vehicles comprises:
acquiring a first entry sequence of the associated vehicles in the traffic road section;
dividing the associated vehicles into target vehicles satisfying an allocation condition and to-be-allocated vehicles based on the first entry sequence and a preset number of lidar channels and determining a second entry sequence of the to-be-allocated vehicles;
determining first lidar channel information of the target vehicles based on the first entry sequence;
determining second lidar channel information of a to-be-allocated vehicle of the to-be-allocated vehicles based on the second entry sequence when a target vehicle of the target vehicles exits the traffic road section; and
determining the first lidar channel information and the second lidar channel information as the lidar channel information.
